(19) United States
(12) Patent Application Publication
(10) Pub. No.: US 2016/0369572 A1
(43) Pub. Date: Dec. 22, 2016

(54) METHODS FOR REPLACING PIN ENDS AND REPAIRING COATINGS ON COATED CONTINUOUS SUCKER RODS

(71) Applicant: LIFTING SOLUTIONS INC., Edmonton, Alberta (CA)

(72) Inventor: Russel Moore, New Sarepta (CA)

(73) Assignee: Lifting Solutions Energy Services Inc., Edmonton, Alberta (CA)

(21) Appl. No.: 15/122,136

(22) PCT Filed: Feb. 28, 2014
(86) PCT No.: PCT/CA2014/000154

§ 371 Date: Aug. 26, 2016

(51) Int. Cl. E21B 17/00; B23P 6/02

(52) U.S. Cl. CPC E21B 17/00; B23P 6/02; E21B 43/127

(57) ABSTRACT

In a method for repairing a fractured coated continuous sucker rod, the pin end segment of the broken rod is discarded, the remaining rod is cut off, and the existing rod coating is trimmed back from the rod cut-off point. A replacement pin end, incorporating a rod portion and an upset pin end, is welded to the cut-off end of the sucker rod. A resilient cylindrical repair sleeve with a longitudinal slit is spread open and urged by radial force over and around the rod portion of the replacement pin end and the adjoining exposed portion of the sucker rod. Using an appropriate fusing apparatus, the edges of the repair sleeve's longitudinal slit are then fused together, and one end of the sleeve is circumferentially fused to the trimmed-back existing coating. Repair sleeves can also be used to repair damaged sections of coating on unfractured sucker rods.

### FIELD

The present disclosure relates in general to methods for replacing pin ends of coated continuous sucker rods used in conjunction with pump jacks and progressive cavity pumps on producing oil wells, and for repairing damaged coatings on coated sucker rods.

### BACKGROUND

In common methods for producing oil from a well drilled into an oil-bearing subsurface formation, a string of steel production tubing is positioned in the wellbore and extends from the subsurface production zone up to a pump jack at surface in accordance with well-known methods, and as schematically illustrated in FIG. 1 herein. A downhole pump is disposed within the production tubing in the production zone to raise well fluids (e.g., oil, gas, formation water) to the surface, by reciprocating vertical movement of a travelling valve incorporated into the pump. The travelling valve is reciprocated by a typically steel “sucker rod” string extending upward within the production tubing to the well where it connects to a polished rod extending upward through a wellhead tee and stuffing box to connect to the “horse head” at the free end of the “walking beam” of the pump jack. By means of a suitable motor and associated mechanical linkage, the pump jack is operable to rock the walking beam such that the horse head reciprocates up and down, thereby alternately raising and lowering the sucker rod and the travelling valve, causing well fluids to be drawn into the well and the production tubing, and to be moved upward within the production tubing toward the wellhead, on each upward stroke of the travelling valve.

As the sucker rod reciprocates within the production tubing, it inevitably comes into contact with the inner wall of the tubing. The resultant friction between the steel sucker rod and the tubing causes wear on both the rod and the tubing. Such wear is a particular problem in “deviated” wells, in which the rod string will unavoidably rub against curved portions of tubing transitioning between vertical and horizontal (or slanted) sections of such wells. In addition to causing wear, the friction between the sucker rod and the tubing increases the magnitude of the force that needs to be provided by the pump jack to raise the sucker rod (and the travelling valve) on each upward stroke.

As an alternative to a pump jack as described above, well fluids may also be produced using a wellhead apparatus that rotates the sucker rod to drive a downhole screw pump (also known as a positive displacement pump), rather than reciprocating the sucker rod up and down. Although rotating sucker rods thus function in a different fashion than reciprocating sucker rods, they are nonetheless prone to friction-induced wear due to contact with the tubing.

Sucker rods are typically round or semi-elliptical in cross-section, and typically hot-rolled from carbon or alloy steel, with diameters ranging from ⅝ to 1⅛ inches. Sucker rods are commonly made up as a string of individual rods (typically 25 to 30 feet in length) threaded together using internally-threaded tubular couplers. The ends of a threaded sucker rod are typically upset (i.e., larger in diameter than the main length of the rod), and are threaded for mating engagement with couplers. The upset portion at each end of a threaded sucker rod is typically about 5 inches long, and includes a tool-engagement (e.g., wrench flats) to facilitate use of a wrench to tighten a coupler onto the rod. The threaded upset ends of a sucker rod are commonly referred to as pin ends.

It is also known to use a continuous (or so-called “endless”) sucker rod instead of a sucker rod string as described above. A continuous sucker rod has only two pin ends; i.e., a lower pin end for connection to the travelling valve of a downhole pump, and an upper pin end for connection to the polished rod. Continuous rod may be several thousand feet in length, depending on the depth to the production zone.

It is known to mitigate the undesirable consequences of friction between sucker rods and production tubing by coating the sucker rods and/or lining the tubing with a low-friction material such as HDPE (high-density polyethylene). Such coatings also provide protection against corrosion in addition to protecting against friction-induced wear. Other polymeric coating materials that may be used for coating sucker rods include but are not limited to polyvinylidene fluoride (PVDF), ethylene tetrafluoro-ethylene (ETFE), polytetrafluoroethylene (PTFE, or “Teflon”®), polyphenylensulfide (PPS, or “Fortron”®), polyamide (nylon), polyester, polyethersulfone, polyethylene terephthalate (PET), polypropylene, polystyrene, epoxy, and acetyl.

International Publication No. WO 2012/109736 (Moore et al.) teaches one process for coating continuous sucker rods with HDPE or other plastic materials. Coated continuous rods have been found to have considerably longer service lives than uncoated rods in comparable operating conditions. For example, in producing wells in Alberta, Canada refitted with continuous sucker rod coated in accordance with WO 2012/109736, rod service life (i.e., operational time before the rod replacement is required due to wear and/or corrosion) have been found to increase from an average of two months (for uncoated continuous rod) to as much as six months, thus greatly reducing downtime and associated costs.

It is not uncommon for sucker rods to fracture due to fatigue after being in service in a producing well for a period of time. These fractures typically occur within one foot (305 mm) or so of upset pin ends of the rod. When a fracture occurs in one section of rod in a jointed sucker rod string, repair is effected by extracting the portion of the rod string above the fracture point, using an appropriate fishing tool to lift the section of the rod string below the fracture (along with the attached travelling valve of the downhole pump) as necessary to fully expose the lower portion of the broken rod section, uncoupling both portions of the broken rod section, and then coupling a replacement section into the rod string. The repaired rod string can then be lowered back into the tubing, and production from the well can resume.

In the case of wells using continuous sucker rods, it has been observed that rod fractures occur much more often near the lower pin end than near the upper pin end. When a continuous sucker rod fractures near its lower pin end, the length of rod above the fracture must be extracted from the well for repair, and the lower pin end (with attached travelling valve) must also be extracted from the tubing. To repair the rod, it is cut off at an undamaged point away from the fractured end, and a new pin end is welded to the rod. When the continuous rod is a coated rod, however, the coating also needs to be repaired. It is highly desirable for the coating repair to restore the integrity of the coating as fully as reasonably possible, particularly in cases where the lower pin end is being replaced. Given that fractures in continuous rods occur most often near their lower pin ends, effective restoration of the integrity of the coating of a coated continuous rod after repair of a rod fracture is an important consideration to protect the replacement pin end and the repair weld zone against corrosion and wear, and thereby to maximize the service life of the repaired coated rod.

### BRIEF SUMMARY

The present disclosure teaches methods for replacing the pin end of a coated continuous sucker rod, for restoring the integrity of the rod coating after replacement of the pin end, and for repairing worn or damaged sections of coating on otherwise serviceable coated sucker rods.

In accordance with the present disclosure, when a fracture has occurred in a coated continuous steel sucker rod near one of its upset pin ends, the portion of the rod extending from the fracture point to and including the pin end is discarded. A transverse cut is made through the remaining portion of the steel rod at a cut-off point a selected distance away from the fracture point, and the rod portion thus cut off is discarded. Either before or after the rod is cut off, the coating on the rod is trimmed back a selected distance from the intended or actual cut-off point. The end of the steel rod at the cut-off point is prepared for welding as appropriate, in accordance with known procedures (for example, circumferential beveling in preparation for a full-penetration groove weld).

The next step is to provide a replacement pin end, incorporating a steel rod portion of a selected length and having the same diameter as the sucker rod being repaired, plus an upset end matching the discarded upset end. Experience suggests that a replacement pin end having a total length of approximately 16 inches (406 mm) will typically be suitable. However, the required length of the replacement pin end may vary depending on the location of the rod fracture and the general condition of the existing sucker rod in a given case.

The free end of the rod portion of the replacement pin end is prepared for welding as appropriate, and then is welded to the prepared cut-off end of the sucker rod. The weld zone is ground down as necessary to match the rod diameter.

The next step is to provide a cylindrical repair sleeve having an inside diameter substantially equal to the diameter of the uncoated rod, and having a length corresponding to the distance between the trimmed-back end of the sucker rod coating and a selected point near the transition between the rod portion and the upset portion of the replacement pin end. (Alternatively, two or more shorter repair sleeves could be used, but the process would otherwise be essentially the same.) The repair sleeve is formed with a generally longitudinal slit, such that the sleeve can be spread open to enable installation of the sleeve over the rod portion of the replacement pin end and the now-adjoining section of the original sucker rod (i.e., between the cut-off end of the original rod and the trimmed-back end of the original coating), by application of radial force to the sleeve to urge it over and around the rod.

The repair sleeve is made from a resilient material, which preferably will match the same material as the coating being repaired. However, the repair sleeve can also be made from a different material if desired or necessary in the circumstances of a particular repair operation.

Optionally, a suitable bonding agent can be applied to the steel rod (or to the inner surfaces of the sleeve) prior to installing the sleeve over the rod, for enhanced anchorage of the sleeve to the rod and for enhanced protection against corrosion.

Due to the resilient nature of the sleeve material, once the repair sleeve has been positioned around the rod portion of the replacement pin end and the adjoining section of the original continuous sucker rod, it will elastically rebound toward its unstressed cylindrical configuration, such that the inner cylindrical surface of the sleeve will come into close and substantially uniform contact with the outer surfaces of the rod portion of the replacement pin end and the adjoining section of the original sucker rod.

With the repair sleeve in place around the replacement pin end as described above, the edges of the longitudinal slit in the repair sleeve preferably will be fused together using an appropriate apparatus of known type to fuse the edges of the slit together. One non-limiting example of such apparatus is the “Injectiweld” plastic welding device available from Drader Manufacturing Industries Ltd. of Edmonton, Alberta.

Preferably, the circumferential end edges of the repair sleeve and the trimmed-back existing rod coating will also be fused together by similar means. In case where it is necessary to repair a sucker rod coating using a repair sleeve made from a different material than the coating, the material used to fuse the end of the sleeve to the existing coating (e.g., plastic welding rods used with an “Injectiweld” device) should be selected for compatibility with the sleeve and coating materials.

Preferably, the longitudinal slit in the repair sleeve will be formed so as to create a longitudinal gap after the sleeve has been disposed around the rod, to facilitate deposition of molten welding rod material during the slit-fusing operation. For similar reasons, the repair sleeve will preferably be longitudinally positioned on the rod so as to create a circumferential gap between the sleeve and the existing coating.

Accordingly, in a first aspect the present disclosure teaches a method for repairing a fractured continuous sucker rod, where the continuous sucker rod prior to fracture comprised an elongate rod section contiguous with a pin end, plus a circumferential plastic coating on the rod section; and where the fracture has resulted in the sucker rod being divided into a broken end segment (comprising the upset pin and an attached remnant of the rod section) and a remaining rod portion. The method in accordance with this first aspect comprises the steps of:
discarding the broken end segment;
cutting off the remaining rod portion at a selected rod cut-off point;
trimming the existing coating on the remaining rod portion back to a coating trim point a selected distance from the rod cut-off point;
providing a replacement pin end incorporating a replacement rod portion and a pin end portion, with the replacement rod portion having a free end;
positioning the replacement pin end in alignment with the remaining rod portion with the replacement rod portion's free end adjacent to the cut-off end of the remaining rod portion;
welding the replacement rod portion's free end to the cut-off end of the remaining rod portion;
providing a repair sleeve having a longitudinal slit;
spreading the longitudinal slit and installing the repair sleeve over and around the replacement rod portion of the replacement pin end and the exposed portion of the remaining rod portion; and
fusing the edges of the longitudinal slit together.

This method preferably includes the further step of fusing an end of the repair sleeve to the existing coating on the remaining rod portion at the coating trim point.

In a second aspect the present disclosure teaches a method for repairing a plastic coating on a sucker rod, comprising the steps of:
removing a damaged portion of the plastic coating between a first coating cut-off point and a second coating cut-off point, thereby exposing a portion of the sucker rod;
providing a repair sleeve having a longitudinal slit, with the repair sleeve being of a length to fit between the first and second coating cut-off points;
spreading the longitudinal slit and installing the repair sleeve over the exposed portion of the sucker rod; and
fusing the edges of the longitudinal slit together.

This method preferably includes the further step of fusing an end of the repair sleeve to the existing coating on the sucker rod at a selected one of the first coating cut-off point and the second coating cut-off point.

### BRIEF DESCRIPTION OF THE DRAWINGS

Embodiments in accordance with the present disclosure will now be described with reference to the accompanying Figures, in which numerical references denote like parts, and in which:

FIG. 1 is schematic illustration of a prior art pump jack reciprocating a sucker rod to operate a downhole pump to produce hydrocarbon fluids from a subsurface formation.

FIGS. 2-4 illustrates sequential steps in one embodiment of a method for replacing an upset pin end of a sucker rod in accordance with the present disclosure.

FIG. 5 is a cross-section through a replacement pin end in accordance with the method step illustrated in FIG. 4, showing a repair sleeve in the process of being mounted around the rod portion of the replacement pin end.

FIG. 6 is a cross-section similar to FIG. 5, showing the repair sleeve fully disposed over and around the rod portion of the replacement pin end.

FIGS. 7-8 illustrate sequential steps in one embodiment of a method for repairing a damaged section of coating on a coated sucker rod in accordance with the present disclosure.

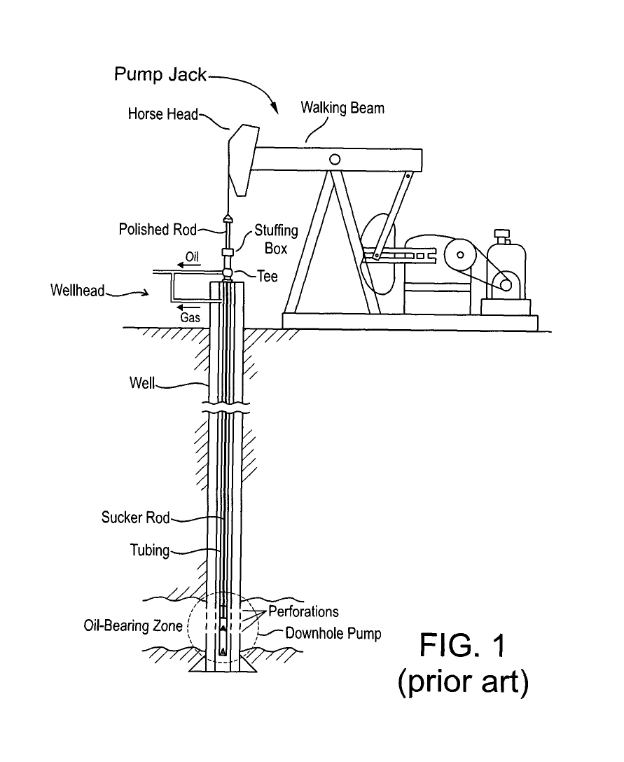

### DETAILED DESCRIPTION

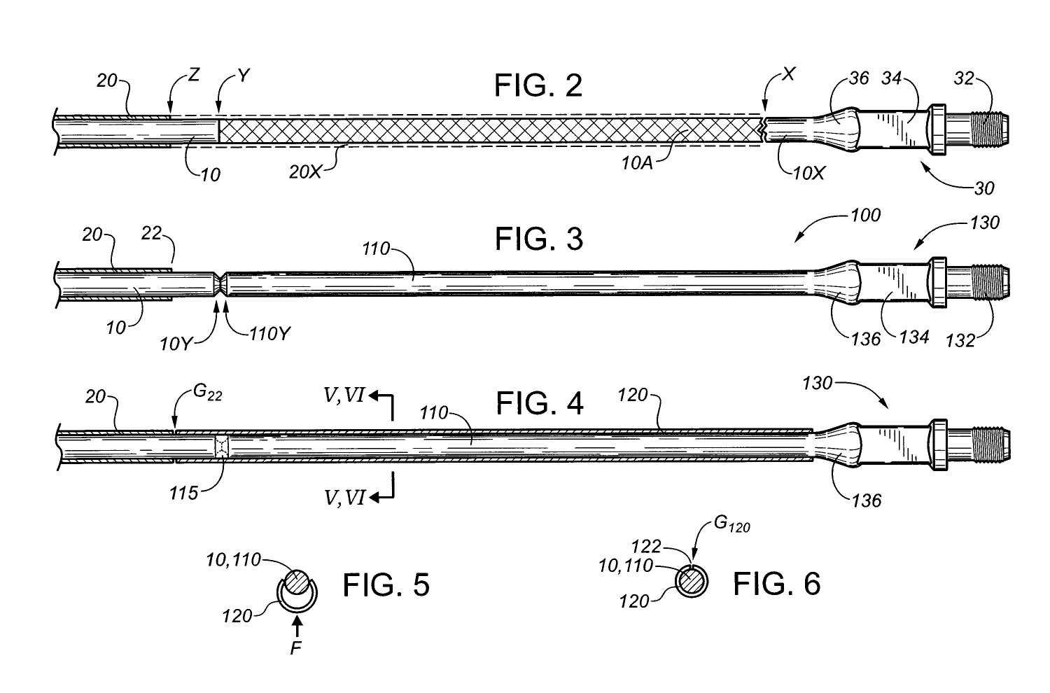

FIG. 2 illustrates the pin end region of a coated continuous steel sucker rod comprising a steel rod 10 (having a coating 20) and an upset pin end 30 (having threads 32, wrench flats 34, and a transition section 36), where rod 10 has experienced a fracture at a point X near upset pin end 30. FIG. 2 also conceptually illustrates steps in one embodiment of a method for replacing the pin end of a fractured coated continuous sucker rod and for repairing the coating after the pin end has been replaced.

As illustrated in FIG. 2, the rod fracture at point X has created a broken end segment outboard of the fracture comprising upset pin end 30 and an attached remnant section 10X of rod 10. One step in the method is to discard the broken end segment. Additional steps are to cleanly cut off the remaining portion of rod 10 at a cut-off point Y a selected distance from fracture point X (discarding the rod portion 10A between fracture point X and cut-off point Y), and to trim coating 20 back to a point Z away a selected distance from cut-off point Y (discarding the trimmed portion 20X of coating 20). The step of trimming coating 20 can be performed either before or after the step of cutting off rod 10 at cut-off point Y.

As illustrated in FIG. 3, the cut-off end 10Y of the remaining rod portion 10 (i.e., at cut-off point Y) is prepared for welding as appropriate. Then, a replacement upset pin end 100, incorporating a steel replacement rod portion 110 (with a free end 110Y) and an upset pin end 130 (with threads 132, wrench flats 134, and a transition section 136), is positioned in alignment with rod 10 as shown, with free end 110Y of replacement rod portion 110 positioned closely adjacent to cut-off end 10Y of rod 10, and with free end 110Y also having been prepared for welding as appropriate. Existing rod end 10Y and replacement rod end 110Y are then welded together to restore required structural strength, and the resultant weld zone 115 is ground down as necessary to match the diameter of the steel rods, as seen in FIG. 4.

With the rod repair phase of the method thus being completed, the next step is to restore or extend the integrity of coating 20 along the full length of the repaired rod. This is achieved by first providing a cylindrical repair sleeve 120, made from a suitable resilient material preferably (but not necessarily) corresponding to the material of coating 20, and having an inside diameter matching the diameter of the uncoated rod(s). (In cases where the sucker rod has a semi-elliptical or other non-circular cross-section, the repair sleeve would have a corresponding configuration.) As illustrated in cross-section in FIGS. 5 and 6, repair sleeve 120 is formed or provided with a longitudinal slit 122, such that repair sleeve 120 can be spread open (using suitable known tools and methods) to temporarily take on a generally C-shaped cross-section so that it can be urged over and around replacement rod 110 (and the exposed portion of existing rod 10 between point Y and point Z) by the application of radial force F as conceptually illustrated in FIG. 5. This results in repair sleeve 120 becoming circumferentially disposed around replacement rod 110 and the exposed portion of existing rod 10 as shown in FIG. 6 (and FIG. 4).

With repair sleeve 120 thus in position, longitudinal slit 122 in sleeve 120 may be sealed by fusing the edges of slit 122 using an appropriate fusing apparatus (such as an “Injectiweld” device or other suitable plastic welding apparatus). Preferably, the repair sleeve 120 and the trimmed-back existing coating 20 will also be fused together by similar means at point Z. In preferred embodiments of the method, longitudinal slit 122 will be formed so as to define a gap G₁₂₀ after the installation of repair sleeve 120 around replacement rod 110, as shown in FIG. 6, to facilitate deposition or injection of molten welding rod material or other fusing material during the slit-fusing step. For similar reasons, repair sleeve 120 will preferably be positioned so as to create a circumferential gap G₂₂ between sleeve 120 and the trimmed-back end 22 of existing coating 20.

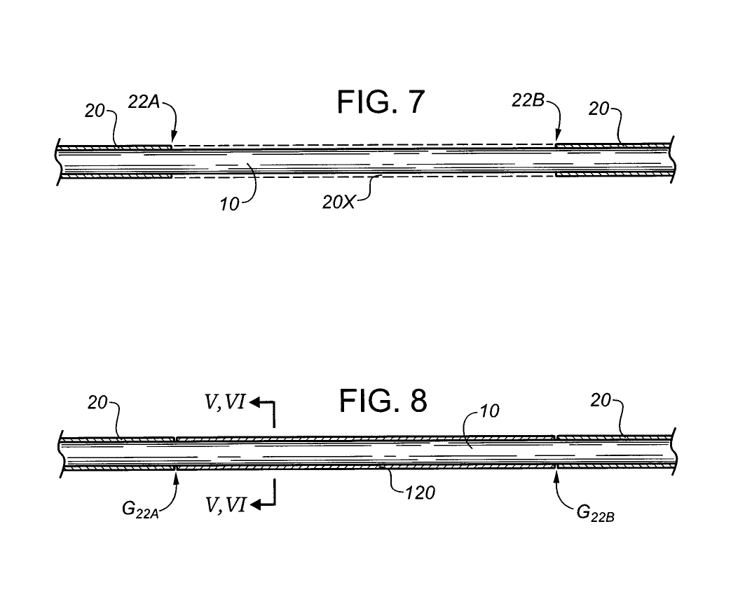

To this point, the present disclosure has addressed coating repair primarily in the context of replacing a pin end on a fractured sucker rod. However, the coating repair methodology previously described herein can be readily adapted for repairing damaged coatings on otherwise serviceable coated sucker rods (including coated jointed sucker rods), as illustrated in FIGS. 7 and 8. In the event that a damaged section of coating 20 is identified during well maintenance and servicing operations, the damaged coating section 20X can be cut out between undamaged coating ends 22A and 22B, as shown in FIG. 7. Then, one or more repair sleeves 120 can be disposed around the exposed section of sucker rod 10 as shown in FIG. 8 (and in FIG. 6), preferably so as to form circumferential gaps G_{22A} and G_{22B} between sleeve(s) 120 and undamaged coating ends 22A and 22B to facilitate effective fusing or sealing between sleeve(s) 120 and the undamaged original coating 20.

It will be readily appreciated by persons skilled in the art that various modifications of embodiments in accordance with the present disclosure may be devised without departing from the scope and teaching of the present disclosure, including modifications which may use materials and apparatus hereafter conceived or developed (such as but not limited to coating materials, sleeve materials, and apparatus and materials for bonding thermoplastics. It is to be especially understood that the disclosure is not intended to be limited to any described or illustrated embodiment, and that the substitution of a variant of a claimed element, step, or feature, without any substantial resultant change in operation or functionality, will not constitute a departure from the intended scope of the claim.

In this patent document, any form of the word “comprise” is to be understood in its non-limiting sense to mean that any item or step following such word is included, but items or steps not specifically mentioned are not excluded. A reference to an element by the indefinite article “a” does not exclude the possibility that more than one of the element is present, unless the context clearly requires that there be one and only one such element. Any use of any form of the word “typical” is to be understood in the non-limiting sense of “common” or “usual”, and not as suggesting essentiality or invariability.

1. A method for repairing a fractured continuous sucker rod, where the continuous sucker rod prior to fracture comprised an elongate rod section contiguous with a pin end, plus a circumferential plastic coating on the rod section, and where the fracture has resulted in the sucker rod being divided into a broken end segment including the upset pin and an attached remnant of the rod section, plus a remaining rod portion, said method comprising:
discarding the broken end segment;
cutting off the remaining rod portion at a selected rod cut-off point;
trimming the existing coating on the remaining rod portion back to a coating trim point a selected distance from the rod cut-off point;
providing a replacement pin end incorporating a replacement rod portion and a pin end portion, said replacement rod portion having a free end;
positioning the replacement pin end in alignment with the remaining rod portion with the replacement rod portion's free end adjacent to the cut-off end of the remaining rod portion;
welding the replacement rod portion's free end to the cut-off end of the remaining rod portion;
providing a repair sleeve having a longitudinal slit;
spreading said longitudinal slit and installing the repair sleeve over and around the replacement rod portion of the replacement pin end and the exposed portion of the remaining rod portion; and
fusing the edges of the longitudinal slit together.

2. The method as in claim 1 further comprising fusing an end of the repair sleeve to the existing coating on the remaining rod portion at the coating trim point.

3. A method for repairing a plastic coating on a sucker rod, said method comprising:
removing a damaged portion of the plastic coating between a first coating cut-off point and a second coating cut-off point, thereby exposing a portion of the sucker rod;
providing a repair sleeve having a longitudinal slit, said repair sleeve being of a length to fit between said first and second coating cut-off points;
spreading said longitudinal slit and installing the repair sleeve over the exposed portion of the sucker rod; and
fusing the edges of the longitudinal slit together.

4. The method as in claim 3 further comprising fusing an end of the repair sleeve to the existing coating on the sucker rod at a selected one of the first coating cut-off point and the second coating cut-off point.
